(19) United States
(12) Patent Application Publication
(10) Pub. No.: US 2026/0270161 A1
(43) Pub. Date: Sep. 10, 2026

(54) DEVICE FOR SERVICE-BASED INTERFACE (SBI) COMMUNICATION WITH AT LEAST ONE CONTROL FUNCTION OF A TELECOMMUNICATION NETWORK, AND METHOD OF OPERATING SAID DEVICE

(71) Applicant: HUAWEI TECHNOLOGIES CO., LTD., Shenzhen (CN)

(72) Inventors: Osama Abboud, Munich (DE); Ramin Khalili, Munich (DE)

(73) Assignee: HUAWEI TECHNOLOGIES CO., LTD., Shenzhen (CN)

(21) Appl. No.: 19/662,683

(22) Filed: Apr. 29, 2026

Related U.S. Application Data
(63) Continuation of application No. PCT/EP2023/080340, filed on Oct. 31, 2023.

(51) Int. Cl. H04L 41/16; H04L 41/5051

(52) U.S. Cl. CPC H04L 41/16; H04L 41/5051

(57) ABSTRACT

Device for Service-Based Interface (SBI) communication with a control function of a telecommunication network. The device comprises a GPT model interface; a NRF interface; a NWDAF interface; and a processor. The processor is configured to retrieve, via the GPT model interface, a GPT model of the SBI communication; retrieve, via the NRF interface, an indication of available services provided by the control function; retrieve, via the NWDAF interface, a real-time state information of the telecommunication network; receive a first service intent or request; validate, using the GPT model, the received first service intent or request; determine, using the GPT model, one or more implementing services of the available services based on the validated first service intent or request and the real-time state information; and send a second service intent or request for at least one of the implementing services.

### CROSS-REFERENCE TO RELATED APPLICATIONS

This application is a continuation of International Application No. PCT/EP2023/080340, filed on Oct. 31, 2023, the disclosure of which is hereby incorporated by reference in its entirety.

### TECHNICAL FIELD

The present disclosure relates generally to the fields of telecommunications and machine learning (ML), and particularly to a device for SBI communication with at least one control function of a telecommunication network, and to a method of operating said device.

### BACKGROUND ART

The 6G system is under development and it is envisioned to have strong usage of ML technologies in order to realize efficient control and interaction. One interesting development of mobile systems is the drastic increase in number of network functions (NF) which offer new services within the mobile network core. Further, the interaction between different NFs becomes multidimensional and requires multiple interaction steps in order to realize a certain functionality. This trend is made more evident via the use of microservices, i.e. dividing larger monolithic services into very small more specific services that can be chained or sequentially called to realize a larger service. Therefore, a major challenge in this context is how to keep the interaction efficient with minimal overhead due to microservices.

Another developing aspect is the strong need in mobile network for realizing intent-based service invocation in which the requesting or consumer NF sends its service intention rather than calling a specific API or service. This increases the flexibility of the interaction but makes it potentially more complex especially with the ever-increasing number of NF types and their offered services. The alternative solution of having complex manual pre-configurations (historically how mobile systems manage their services) is limited and does not offer flexibility and configurability.

Further, the use of ML in mobile systems has been increasing and the so-called Network Data Analytics Function (NWDAF) has been defined to handle data analytics and ML in mobile systems. This development is supported by the huge interest by different standardization bodies to use machine learning with a promise on simplifying network design and improved performance. However, so far, the NWDAF is used mostly as black-box in which it is assumed it can solve a problem given enough data from the network.

In general, current networks do not support intent based control. This leads to increased manual configuration and troubleshooting issues as well as increased potential of down downtime due to rigid API call methodology.

Furthermore, current networks suffer from scalability issues. This is due to the fact that the combination of a huge number of NF types, deployment locations, slices, and the huge number of possible functions call to individual NFs, create a huge number of possibilities on how to execute and realize a service. In addition, creation of new NFs and their interfaces is cumbersome and fault sensitive. In case an interface fails, the whole request from the UE fails, even though there are alternatives ways to realize a request. Current systems cannot generalize from previous experience of API calls to realize new calls. Therefore, they cannot interpret service level intents. In general, current dynamic realization of function calls is through some manual configuration and translation functions that have limited room for realizing dynamic behaviors and strong reliance on administration and configuration managers.

Based on those aspects, the 6G network does not support smart SBA interactions that allows for flexibility and dynamicity to quickly react to evolving interfaces and service points as well as elegantly handle errors. Further no generalization of interactions between NF is possible.

### SUMMARY

It is an object to overcome the above-mentioned and other drawbacks.

The foregoing and other objects are achieved by the features of the independent claims. Further implementation forms are apparent from the dependent claims, the description and the figures.

According to a first aspect, a device is provided for Service-Based Interface, SBI, communication with at least one control function of a telecommunication network. The device comprises a Generative Pretrained Transformer, GPT, model interface; a Network Repository Function, NRF, interface; a Network Data Analytics Function, NWDAF, interface; and a processor. The processor is configured to: retrieve, via the GPT model interface, a GPT model of the SBI communication; retrieve, via the NRF interface, an indication of available services provided by the control functions; retrieve, via the NWDAF interface, a real-time state information of the telecommunication network; receive a first service intent or first service request; validate, using the GPT model, the received first service intent or first service request; determine, using the GPT model, one or more implementing services of the available services based on the validated first service intent or first service request and the real-time state information; and send a second service intent or second service request for at least one of the implementing services.

This has the following benefits/advantages:
intent-based interaction between the different NFs and UE towards a network core (i.e., a service requestor may send its intention and potential outcome of the request rather than the request itself);
continuous self-learning procedures allowing the translation criteria, rules, and policies to be automatically updated and modified in a dynamic manner based on the current network conditions;
continuous learning of interfaces from specifications and interactions between NFs (NWDAF, AF, NRF, . . . );
continuous interaction with new NF types;
reducing the required number of interactions;
the GPT SBA acting as a single point of interaction between consumer and provider NFs, responding to NFs without interacting with NRF;
flexibility;
generalization of the learned interaction logic (e.g., multiple calls at once, multi NF procedures (e.g., chaining), (conditional) request processing based on input from other NFs);
integrating new interfaces by querying the list of interfaces; and
soft error handling.

As used herein, a Network Function or NF may refer to a functional network entity or building block originating from virtualization of network infrastructure and being connectable or chainable with other NFs to create and deliver services. NFs may be distinguished according to their role in service invocation (consumer NF, or provider NF, or cloud service NF) or according to their plane of engagement (control plane (network) function, user plane (network) function/UPF, or cloud-based (network) function), for example.

As used herein, a Service-Based Interface or SBI may refer to an API-based communication within a Service-Based Architecture.

As used herein, a Service-Based Architecture or SBA may refer to a functional network architecture whose NFs communicate to one another via SBIs that are specific to the respective endpoint/NF rather than via point-to-point (P2P) interfaces that are specific to the respective pair of endpoints.

As used herein, a Generative Pretrained Transformer or GPT may refer to an artificial neural network of Transformer type being (pre-)trained using self-or semi-supervised learning and/or using reinforcement learning of massive amounts of training data, thereby acquiring its patterns and structure and being capable of generating new data that has similar characteristics.

As used herein, a Network Repository Function or NRF may refer to a control NF of a telecommunication network that provides registration and service discovery functionality by maintaining profiles of NF instances and their supported services, so that NFs can discover one another and communicate via SBIs.

As used herein, a Network Data Analytics Function or NWDAF may refer to a control NF of a telecommunication network that collects data by subscription or request models from terminals (UEs), network entities (NFs) and operations, administration, and maintenance (OAM) systems, computes analytics based on the collected data and a specific data model (e.g., and AI/ML model), and shares the analytics with other functions in the network (the data analytics consumers).

As used herein, a real-time state information may refer to an instantaneous utilization of a telecommunication network, such as in terms of an allocation of communication resources, a workload of NFs, and the like.

As used herein, a service request may refer to a form of service invocation wherein a service requestor (i.e., UE or consumer NF) provides detailed requirements on and configuration parameters of a desired service in accordance with a specific SBI.

As used herein, a service intent(ion) may refer to a form of service invocation wherein a service requestor provides operational guidance and information about underlying goals and purposes of a desired service.

In a possible implementation form, the processor may further be configured to receive a second service response to the sent second service intent or second service request; validate, using the GPT model, the received second service response; and send a first service response to the received first service intent or first service request, depending on a success of the validation.

This enables a successful conclusion of a service invocation.

As used herein, a validation may refer to proving if something is correct or accurate.

In a possible implementation form, the sent second service intent or service request may be sent to a first provider network function, NF.

This enables a multi-NF service invocation.

In a possible implementation form, the received second service response may be received from the first provider NF.

This enables a sequential multi-NF service invocation.

In a possible implementation form, the received second service response may be received from a second provider NF, the second provider NF being different from the first provider NF and being determined using the GPT model.

This enables a chained multi-NF service invocation (service function chaining/SFC).

In a possible implementation form, the processor may further be configured to falsify, using the GPT model, a realization of the first service intent or first service request by the validated second service response; and send a second service intent or second service request for another one of the implementing services, depending on a success of the falsification.

This enables a dynamic multi-NF service invocation.

As used herein, a falsification may refer to proving if something is false.

In a possible implementation form, the processor may further be configured to determine, using the GPT model, a feedback based on an invalid or incomplete first service intent or first service request; and send the determined feedback.

In a possible implementation form, the feedback may comprise a correction or query with respect to the invalid or incomplete first service intent or first service request.

This enables soft error handling.

As used herein, a correction may refer to a suggested variation of the invalid or incomplete first service intent or first service request as determined by the GPT model.

As used herein, a query may refer to a choice of suggested variations of the invalid or incomplete first service intent or first service request as determined by the GPT model.

In a possible implementation form, the received first service intent or first service request may be received from a UE or a consumer NF.

This enables service invocation by terminals or network entities.

In a possible implementation form, the device may form an integral part of a Service-Based Architecture, SBA, of the telecommunication network.

This enables direct service invocation.

In a possible implementation form, the device may form part of a standalone NF of the telecommunication network and may be configured to act as a service proxy.

This enables indirect service invocation via the service proxy.

As used herein, a service proxy may refer to a NF acting on behalf of provider NFs.

In a possible implementation form, the device may further comprise the GPT model.

This enables full control of the learning/training phase of the GPT model.

In a possible implementation form, the GPT model may be configured to learn potential feedback in response to the invalid or incomplete first service intent or first service request.

This enables learned soft error handling.

In a possible implementation form, the GPT model may be configured to learn a determination of the implementing services based on the validated first service intent or first service request and the real-time state information from one or more of: SBI standards documents; SBI features in terms of the available services and corresponding usage scenarios; SBI API specifications of individual provider NFs defined in machine-readable language; recorded SBI interactions and service invocations;
log files of the individual provider NFs; log files of individual consumer NFs; NRF information; and log files of NRFs.

This enables learning of a decomposition into implementing services.

In a possible implementation form, the telecommunication network may comprise a mobile network.

This enables deploying the device in mobile networks, not least in 5^{th} generation (5G) and 6^{th} generation (6G) 3GPP networks.

According to a second aspect, a telecommunication network is provided, comprising a device of the first aspect or any one of its implementations. The processor may further be configured to receive the first service intent or first service request from outside of an administrative dominion of the telecommunication network; and send a second service intent or second service request for at least one of the implementing services to the outside of the administrative dominion of the telecommunication network.

This enables service invocation via SBIs for UEs as well as cloud providers, as the SBI bus may be extended beyond the core network, i.e., across the air interface as well as to cloud systems.

As used herein, an administrative dominion may refer to a scope of administrative power which may extend within administrative boundaries of an organization, for instance.

According to a third aspect, a method is provided of operating a device for Service-Based Interface, SBI, communication with at least one control function of a telecommunication network. The device comprises a Generative Pretrained Transformer, GPT, model interface; a Network Repository Function, NRF, interface; and a Network Data Analytics Function, NWDAF, interface. The method comprises: retrieving, via the GPT model interface, a GPT model of an API communication of the SBI; retrieving, via the NRF interface, an indication of available services provided by the control functions; retrieving, via the NWDAF interface, a real-time state information of the telecommunication network; receiving a first service intent or first service request; validating, using the GPT model, the received first service intent or first service request; and determining, one or more implementing services of the available services using the GPT model, based on the validated first service intent or first service request and the real-time state information; and sending a second service intent or second service request for at least one of the implementing services.

In a possible implementation form, the method may be performed by the device of the first aspect or any one of its implementations.

According to a fourth aspect, a computer program is provided, comprising a program code for performing the method of the third aspect or any one of its implementations when executed on a computer.

According to a fifth aspect, a user equipment, UE, is provided, comprising a processor being configured to: send a first service intent or first service request to a device for Service-Based Interface, SBI, communication with at least one control function of a telecommunication network; and receive a first service response to the received first service intent or first service request.

In a possible implementation form, the processor may further be configured to receive a feedback with respect to an invalid or incomplete first service intent or first service request.

In a possible implementation form, the feedback may comprise a correction or query with respect to the invalid or incomplete first service intent or first service request.

The technical effects and advantages described above in relation with the device of the first aspect equally apply to the second to fifth aspects having corresponding features.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary device in accordance with the present disclosure;

FIG. 2 illustrates an exemplary 5G SBA-integrated implementation of the device of FIG. 1;

FIG. 3 illustrates an exemplary 5G standalone NF implementation of the device of FIG. 1;

FIG. 4 illustrates an exemplary 6G implementation of the device of FIG. 1;

FIG. 5 illustrates an exemplary method in accordance with the present disclosure;

FIG. 6 illustrates an exemplary sequential or dynamic call based on the method of FIG. 5;

FIG. 7 illustrates an exemplary PDU Session Creation as a concrete example based on the method of FIG. 5; and

FIG. 8 illustrates an exemplary service function chaining (SFC) based on the method of FIG. 5.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

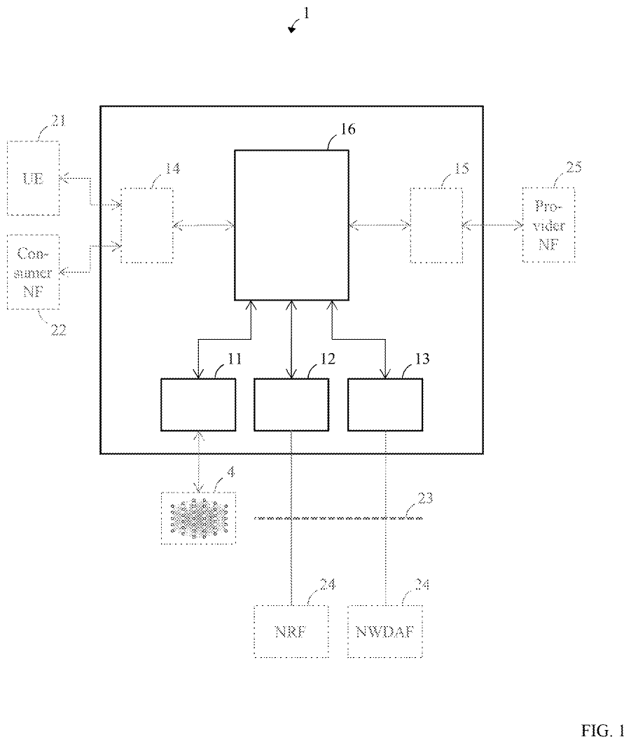

FIG. 1 illustrates a device 1 in accordance with the present disclosure.

The device 1 is suited for SBI communication with at least one control function 24 of a telecommunication network 2.

For example, the telecommunication network 2 may comprise a mobile (i.e., 3GPP) network.

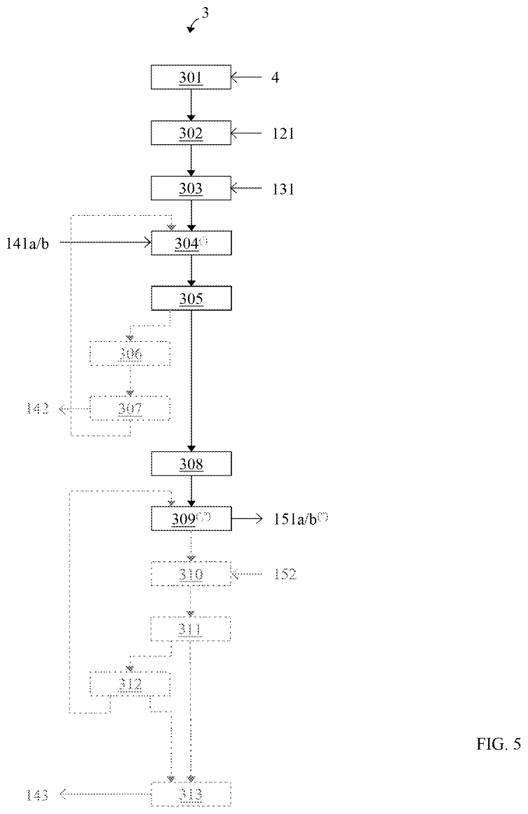

The device 1 comprises a processor 16, which may, for instance, comprise (a virtualized portion of) an application specific integrated circuit (ASIC), field-programmable gate array (FPGA), network processing unit (NPU), digital signal processor (DSP), microprocessor (μP), or generally any processing logic being configured to perform the method 3 of the third aspect or any one of its implementations (see FIG. 5).

The processor 16 is configured to retrieve 301, via a GPT model interface 11 of the device 1, a GPT model 4 of the SBI communication (Ngpt_obtain_model).

The processor 16 is further configured to retrieve 302, via an NRF interface 12 of the device 1, an indication 121 of available services provided by the control functions 24 (Nnrf_get_services).

The processor 16 is further configured to retrieve 303, via an NWDAF interface 13 of the device 1, a real-time state information 131 of the telecommunication network 2 (Nnwdaf_subscribe).

In FIG. 1, note that the NRF interface 12 and the NWDAF interface 13 respectively merge in the SBI bus 23 which provides the connectivity to the NRF and NWDAF control NFs 24.

The processor 16 is further configured to receive 304 a first service intent 141a or first service request 141b (Nue_gpt_sba). This may take place via a service consumer interface 14 of the device 1.

The received first service intent 141a or first service request 141b may be received from a user equipment, UE 21, or a consumer NF 22.

For its part, the UE 21 comprises a processor 211 being configured to send the first service intent 141a or first service request 141b to the device 1.

The processor 16 is further configured to validate 305, using the GPT model 4, the received first service intent 141a or first service request 141b.

In case of a first service intent 141a, a congruent service request 141b is detected based on the GPT model.

The body of the service request will be validated against the GPT model. It will basically check if the input is as expected and as per the trained data.

The processor 16 may further be configured to determine 306, using the GPT model 4, a feedback 142 based on an invalid or incomplete first service intent 141a or first service request 141b; and send 307 the determined feedback 142.

If the service request is invalid, the feedback 142 will be returned rather than a simple error message, since that will not be helpful for the service requestor.

Here, prompt engineering may be applied so that the initial request produces the best answer possible and without many back-and-forth interactions. Prompt engineering may refer to an engineering and design-based approach to formulate the incoming intent or request towards the GPT module.

On the side of the UE 21, the processor 211 may further be configured to receive a feedback 142 with respect to an invalid or incomplete first service intent 141a or first service request 141b.

The feedback 142 may comprise a correction or query with respect to the invalid or incomplete first service intent 141a or first service request 141b. For example, the feedback 142 may comprise a suggestion for a corrected service intent 141a or a query including a choice of suggestions for a corrected service intent 141a, consistently being in compliance with the GPT model 4.

The processor 16 is further configured to determine 308, using the GPT model 4, one or more implementing services 41 of the available services based on the validated first service intent 141a or first service request 141b and the real-time state information 131.

In other words, the service request is decomposed into the one or more underlying NF requests. For example, the GPT model 4 will transform a service request such as PDU session setup for the UE with ID 1111 and give it access to a low latency slice into multiple requests to the SMF, NSSMF and AMF that trigger the underlying required requests as per the trained data.

The processor 16 is further configured to send 309 a second service intent 151a or second service request 151b for at least one of the implementing services 41 (Nnf_service_call). This may take place via a service provider interface 15 of the device 1.

The device 1 is configured to handle multiple (potentially parallel) requests and make sure each provider NF 25 returns a valid response 152:

The processor 16 may further be configured to receive 310 a second service response 152 to the sent second service intent 151a or second service request 151b; validate 311, using the GPT model 4, the received second service response 152; and send 313 a first service response 143 to the received first service intent 141a or first service request 141b, depending on a success of the validation.

On the side of the UE 21, the processor 211 is further configured to receive a first service response 143 to the received first service intent 141a or first service request 141b.

According to an implementation, the device 1 may further comprise the GPT model 4.

The GPT model 4 may be configured to learn potential feedback 142 in response to the invalid or incomplete first service intent 141a or first service request 141b.

The GPT model 4 may be configured to learn a determination of the implementing services 41 based on the validated first service intent 141a or first service request 141b and the real-time state information 131 from one or more of: SBI standards documents; SBI features in terms of the available services and corresponding usage scenarios; SBI API specifications of individual provider NFs defined in machine-readable language; recorded SBI interactions and service invocations; log files of the individual provider NFs; log files of individual consumer NFs; NRF information; and log files of NRFs.

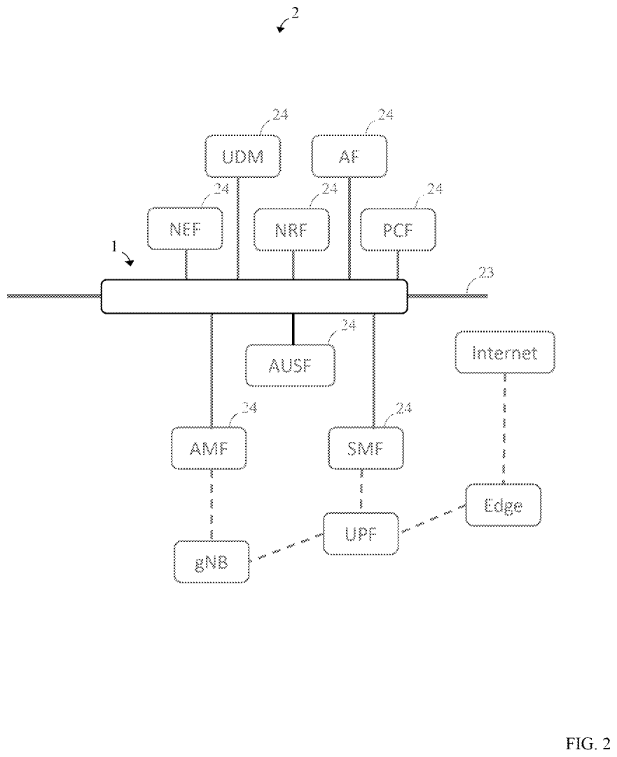

FIG. 2 illustrates a 5G SBA-integrated implementation of the device 1 of FIG. 1.

The SBA of the telecommunication network 2 comprises typical control NFs 24 being connected via an SBI bus 23 (solid lines). The telecommunication network 2 further comprises typical user plane NFs being connected via P2P interfaces (dashed lines).

The device 1 may form an integral part of the SBA, being indicated in FIG. 2 by the SBI bus 23 “integrating” the device 1. In other words, the device 1 is directly integrated into the SBI bus 23 and service requestors are not aware of its existence as it is completely transparent. The device 1 is inherently aware of the SBI communication of the telecommunication network 2.

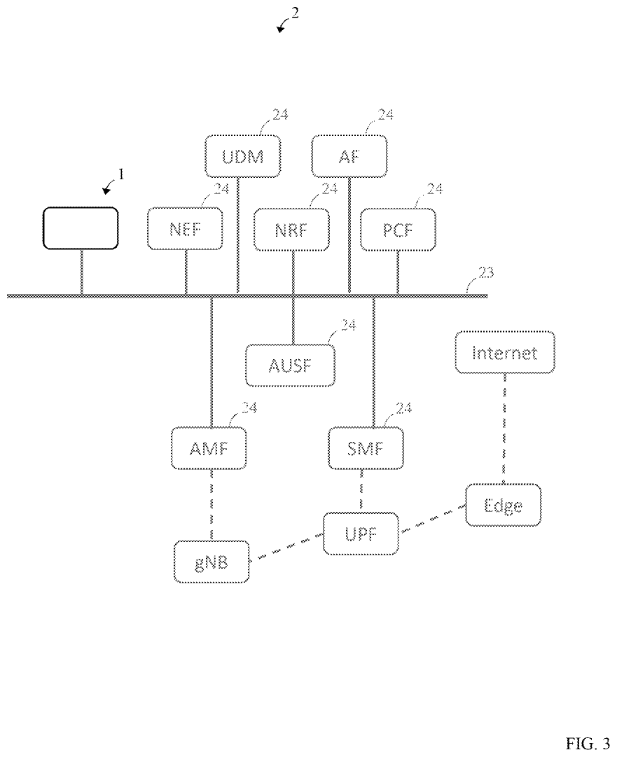

FIG. 3 illustrates a 5G standalone NF implementation of the device 1 of FIG. 1.

Again, the SBA of the telecommunication network 2 comprises typical control NFs 24 being connected via an SBI bus 23 (solid lines). The telecommunication network 2 further comprises typical user plane NFs being connected via P2P interfaces (dashed lines).

The device 1 may form part of a standalone NF of the telecommunication network 2, being indicated in FIG. 3 by a further control NF 1 on the SBI bus 23 which is configured to act as a service proxy. In other words, service requestors need to discover the further control NF 1 via the NRF 24 and then address to the further control NF 1 acting as their service proxy.

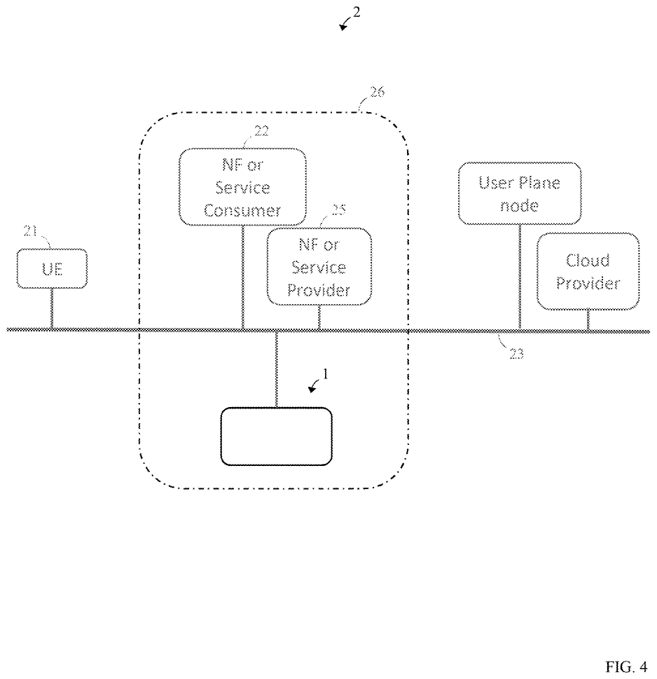

FIG. 4 illustrates a 6G implementation of the device 1 of FIG. 1.

In 6^{th} generation (6G) architectures, the SBI bus 23 may be extended beyond the core network, i.e., across the air interface and reaching out to cloud providers. This enables service invocation via SBIs by UEs 21, user plane nodes and cloud providers.

In this context, the device 1 may form part of a standalone NF of the telecommunication network 2, being indicated in FIG. 4 by a further control NF 1 on the SBI bus 23 which is configured to act as a service proxy.

Its processor 16 may thus be configured to receive 304′ the first service intent 141a or first service request 141b from outside of an administrative dominion 26 of the telecommunication network 2; and send 309′ a second service intent 151a′ or second service request 151b′ for at least one of the implementing services 41 to the outside of the administrative dominion 26 of the telecommunication network 2.

FIG. 5 illustrates a method 3 in accordance with the present disclosure.

The method 30 defines an operation of the device 1 of the first aspect or any one of its implementations. Conversely, the method 30 may be performed by the device 1 of the first aspect or any one of its implementations.

The method 30 comprises a step of retrieving 301, via a GPT model interface 11 of the device 1, a GPT model 4 of an API communication of the SBI.

The method 30 further comprises a step of retrieving 302, via an NRF interface 12 of the device 1, an indication 121 of available services provided by the control functions 24.

The method 30 further comprises a step of retrieving 303, via an NWDAF interface 13 of the device 1, a real-time state information 131 of the telecommunication network 2.

The method 30 further comprises a step of receiving 304 a first service intent 141a or first service request 141b.

The method 30 further comprises a step of validating 305, using the GPT model 4, the received first service intent 141a or first service request 141b.

The method 30 may further comprise steps of determining 306, using the GPT model 4, a feedback 142 based on an invalid or incomplete first service intent 141a or first service request 141b; and sending 307 the determined feedback 142.

The method 30 further comprises a step of determining 308, one or more implementing services 41 of the available services using the GPT model 4, based on the validated first service intent 141a or first service request 141b and the real-time state information 131.

The method 30 further comprises a step of sending 309 a second service intent 151a or second service request 151b for at least one of the implementing services 41.

The method 30 may further comprise steps of receiving 310 a second service response 152 to the sent second service intent 151a or second service request 151b; validating 311, using the GPT model 4, the received second service response 152; and sending 313 a first service response 143 to the received first service intent 141a or first service request 141b, depending on a success of the validation.

The method 30 may further comprise an intermediate step of falsifying 312, using the GPT model 4, a realization of the first service intent 141a or first service request 141b by the validated second service response 152; and send 309″ a second service intent 151a″ or second service request 151b″ for another one of the implementing services 41, depending on a success of the falsification.

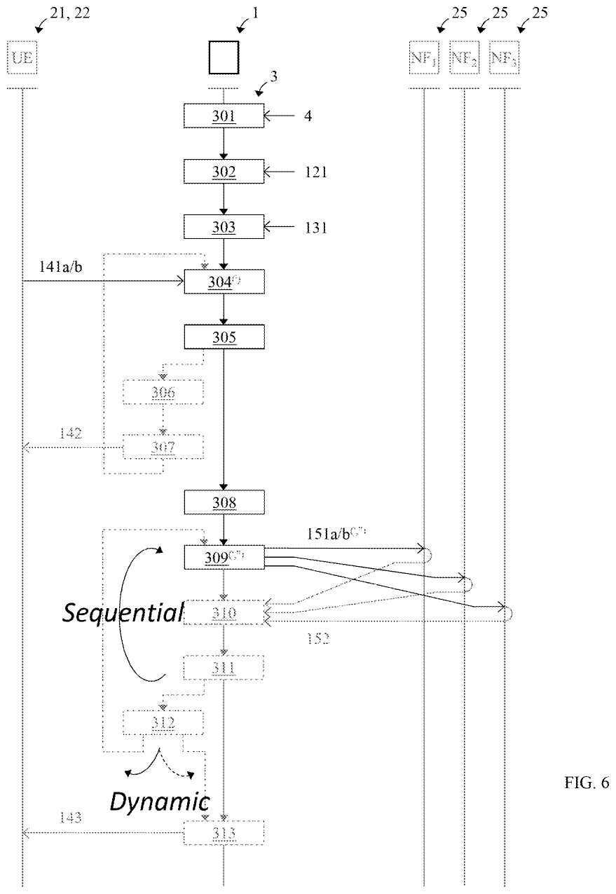

FIG. 6 illustrates a sequential or dynamic call based on the method 3 of FIG. 5.

In this example, the first service intent 141a or service request 141b may paraphrase or comprise a UE request for registration, session, etc.

The sent second service intent 151a or service request 151b may, for instance, paraphrase or comprise an SBI call to a first provider NF 25 (NF₁), and the received second service response 152 may be received from the first provider NF 25 (NF₁).

This message exchange repeats for an intermediate provider NF 25 (NF₂) and the second (i.e., last) provider NF 25 (NF₃).

That is to say, the provider NFs 25 (NF₁, NF2, NF₃) may receive the respective second service request 151b sequentially, under intermittent control of the device 1.

As used herein, “sequential” may mean one after another (see loop 309-310-311-312-309- . . . ), and “dynamic” may mean depending on the success of the preceding request 151b (see branch at 312).

To this end, the processor 16 may further be configured to falsify 312, using the GPT model 4, a realization of the first service intent 141a or first service request 141b by the validated second service response 152; and send 309″ a second service intent 151a″ or second service request 151b″ for another one of the implementing services 41, depending on a success of the falsification.

The resulting first service response 143 may comprise a UE response for registration, session, etc.

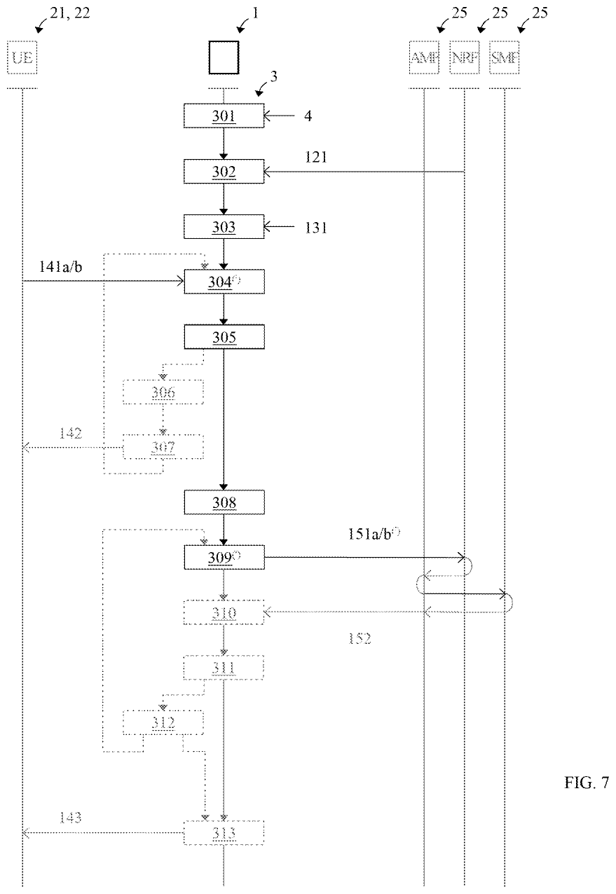

FIG. 7 illustrates a PDU Session Creation as a concrete example based on the method 3 of FIG. 5.

In this example, the first service intent 141a or service request 141b may paraphrase or comprise a Session Establishment Request.

The second service intent 151a or service request 151b may paraphrase or comprise a Session Establishment Request directed to an Access and Mobility Management Function (AMF) 25 of the telecommunication network 2.

Then, the AMF 25 may address to a Network Repository Function (NRF) 25 of the telecommunication network 2 to perform service discovery. The NRF 25 may return a list of Session Management Functions (SMF) 25 in response.

Next, the AMF 25 may address to one of the SMFs 25 of the telecommunication network 2 to perform session establishment. The SMF 25 may return session management context data in response.

Subsequently, the AMF 25 may return a Session Establishment Response as the first service response 152.

The resulting first service response 143 may also comprise a Session Establishment Response.

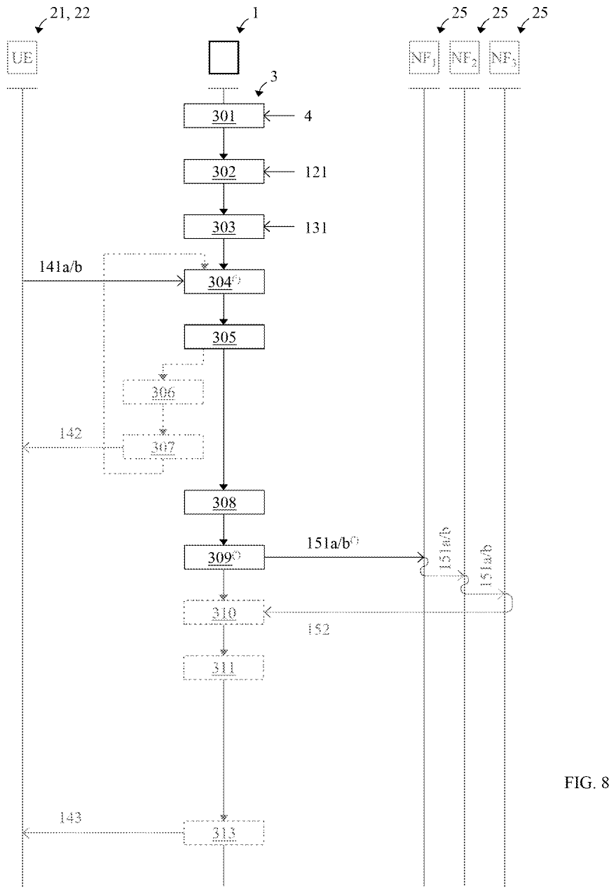

FIG. 8 illustrates service function chaining (SFC) based on the method 3 of FIG. 5.

In this example, the first service intent 141a or service request 141b may comprise a UE request for registration, session, etc.

The sent second service intent 151a or service request 151b may be sent to a first provider NF 25 (NF₁), and the received second service response 152 may be received from a second provider NF 25 (NF₃), wherein the second provider NF 25 (NF₃) differs from the first provider NF (NF₁) and has been determined 308 using the GPT model 4.

In other words, the provider NFs 25 (NF₁, NF2, NF₃) may receive the respective second service request 151b sequentially in accordance with the SFC determined 308 by the GPT model 4, i.e., without intermittent control of the device 1.

The resulting first service response 143 may comprise a UE response for registration, session, etc.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. A device for Service-Based Interface, SBI, communication with at least one control function of a telecommunication network, comprising:
a Generative Pretrained Transformer, GPT, model interface;
a Network Repository Function, NRF, interface;
a Network Data Analytics Function, NWDAF, interface; and
a processor, being configured to:
retrieve, via the GPT model interface, a GPT model of the SBI communication;
retrieve, via the NRF interface, an indication of available services provided by the control functions;
retrieve, via the NWDAF interface, a real-time state information of the telecommunication network;
receive a first service intent or first service request;
validate, using the GPT model, the received first service intent or first service request;
determine, using the GPT model, one or more implementing services of the available services based on the validated first service intent or first service request and the real-time state information; and
send a second service intent or second service request for at least one of the implementing services.

2. The device of claim 1,
the processor further being configured to:
receive a second service response to the sent second service intent or second service request;
validate, using the GPT model, the received second service response; and
send a first service response to the received first service intent or first service request, depending on a success of the validation.

3. The device of claim 2,
the sent second service intent or service request being sent to a first provider network function, NF.

4. The device of claim 2,
the received second service response being received from the first provider NF.

5. The device of claim 2,
the received second service response being received from a second provider NF, the second provider NF being different from the first provider NF and being determined using the GPT model.

6. The device of claim 2,
the processor further being configured to:
falsify, using the GPT model, a realization of the first service intent or first service request by the validated second service response; and
send a second service intent or second service request for another one of the implementing services, depending on a success of the falsification.

7. The device of claim 1,
the processor further being configured to:
determine, using the GPT model, a feedback based on an invalid or incomplete first service intent or first service request; and
send the determined feedback.

8. The device of claim 7,
the feedback comprising a correction or query with respect to the invalid or incomplete first service intent or first service request.

9. A method of operating a device for Service-Based Interface, SBI, communication with at least one control function of a telecommunication network,
the method comprising:
retrieving, via a Generative Pretrained Transformer, GPT, model interface of the device, a GPT model of an API communication of the SBI;
retrieving, via a Network Repository Function, NRF, interface of the device, an indication of available services provided by the control functions;
retrieving, via a Network Data Analytics Function, NWDAF, interface of the device, a real-time state information of the telecommunication network;
receiving a first service intent or first service request;
validating, using the GPT model, the received first service intent or first service request;
determining, one or more implementing services of the available services using the GPT model, based on the validated first service intent or first service request and the real-time state information; and
sending a second service intent or second service request for at least one of the implementing services.

10. The method of claim 9,
being performed by
a device for Service-Based Interface, SBI, communication with at least one control function of a telecommunication network, comprising:
a Generative Pretrained Transformer, GPT, model interface;
a Network Repository Function, NRF, interface;
a Network Data Analytics Function, NWDAF, interface; and
a processor, being configured to:
retrieve, via the GPT model interface, a GPT model of the SBI communication;
retrieve, via the NRF interface, an indication of available services provided by the control functions;
retrieve, via the NWDAF interface, a real-time state information of the telecommunication network;
receive a first service intent or first service request;
validate, using the GPT model, the received first service intent or first service request;
determine, using the GPT model, one or more implementing services of the available services based on the validated first service intent or first service request and the real-time state information; and
send a second service intent or second service request for at least one of the implementing services.

11. A user equipment, UE, comprising
a processor, being configured to:
send a first service intent or first service request to a device for Service-Based Interface, SBI, communication with at least one control function of a telecommunication network; and
receive a first service response to the received first service intent or first service request.

12. The UE of claim 11,
the processor further being configured to
receive a feedback with respect to an invalid or incomplete first service intent or first service request.

13. The UE of claim 12,
the feedback comprising a correction or query with respect to the invalid or incomplete first service intent or first service request.
